(19) United States
(12) Patent Application Publication
(10) Pub. No.: US 2013/0234858 A1
(43) Pub. Date: Sep. 12, 2013

(54) WEIGHT SENSING DEVICE AND WEIGHT SENSING SYSTEM

(71) Applicants: WINTEK (CHINA) TECHNOLOGY LTD., Dongguan City (CN); WINTEK CORPORATION, Taichung City (TW)

(72) Inventors: Chin-Liang Chen, Taichung City (TW); Zhi-Ting Ye, Miaoli County (TW); Ming-Chuan Lin, Taichung City (TW)

(73) Assignees: WINTEK CORPORATION, Taichung City (TW); WINTEK (CHINA) TECHNOLOGY LTD., Dongguan City (CN)

(21) Appl. No.: 13/794,744

(22) Filed: Mar. 11, 2013

(30) Foreign Application Priority Data
Mar. 12, 2012 (TW) 101108304

(51) Int. Cl. G08B 21/18

(52) U.S. Cl. CPC G08B 21/182
USPC 340/666

(57) ABSTRACT

A weight sensing device includes a casing, a weight sensing module and a light emitting module. A container placing area and a light emitting area are defined on a surface of the casing and staggered with each other. The weight sensing module is disposed in the casing and corresponding to the container placing area. The weight sensing module records a weight threshold. The light emitting module is disposed in the casing and corresponding to the light emitting area. When a container, which contains a substance, is placed on the container placing area, the weight sensing module senses a current weight of the container and the substance and compares the current weight with the weight threshold. When the current weight is smaller than the weight threshold, the weight sensing module drives the light emitting module to emit light, which is projected through the light emitting area.

### BACKGROUND OF THE INVENTION

1. Field of the Invention

The invention relates to a weight sensing device and a weight sensing system and, more particularly, to a weight sensing device and a weight sensing system capable of sensing a weight of a container and a substance therein and selectively generating a notification message according to the weight.

2. Description of the Prior Art

Many stores, restaurants, consumer spaces, and so on nowadays supply consumers with water or beverage. Furthermore, some stores may place a cup, which contains water or beverage, on a cup pad so as to prevent the cup from moving and prevent the liquid in the cup from slopping. In general, when a waiter or waitress observes that the water in the cup decreases or the cup is empty, he or she will add water for the consumer actively. However, if the waiter or waitress does not observe that the cup has been empty in time and the consumer cannot find any waiter or waitress, the consumer can only sit on his or her seat without water to drink such that the store may make a bad impression and service quality on the consumer.

### SUMMARY OF THE INVENTION

Therefore, an objective of the invention is to provide a weight sensing device and a weight sensing system capable of sensing a weight of a container and a substance therein and selectively generating a notification message according to the weight, so as to solve the aforesaid problems.

According to an embodiment of the invention, a weight sensing device comprises a casing, a weight sensing module and a light emitting module. A container placing area and a light emitting area are defined on a surface of the casing and staggered with each other. The weight sensing module is disposed in the casing and corresponding to the container placing area. The weight sensing module records a weight threshold. The light emitting module is disposed in the casing and corresponding to the light emitting area. The light emitting module is electrically connected to the weight sensing module. When a container, which contains a substance, is placed on the container placing area, the weight sensing module senses a current weight of the container and the substance and compares the current weight with the weight threshold. When the current weight is smaller than the weight threshold, the weight sensing module drives the light emitting module to emit light, which is projected through the light emitting area.

According to another embodiment of the invention, a weight sensing system comprises a weight sensing device, a signal detecting module and a notification module, wherein the notification module communicates with the signal detecting module. The weight sensing device comprises a casing, a weight sensing module and a signal generating module. The weight sensing module is disposed in the casing and records a weight threshold. The signal generating module is disposed in the casing and electrically connected to the weight sensing module. When a container, which contains a substance, is placed on the casing, the weight sensing module senses a current weight of the container and the substance and compares the current weight with the weight threshold. When the current weight is smaller than the weight threshold, the weight sensing module drives the signal generating module to generate a first signal. The signal detecting module detects the first signal and then transmits a second signal to the notification module. The notification module generates a notification message according to the second signal.

As mentioned in the above, the weight sensing device of the invention can sense the current weight of the container (e.g. cup, bowl, pot, etc.) and the substance (e.g. water, beverage, soup, etc.) therein and emit light through the light emitting area when the current weight is smaller than the weight threshold, so as to notify a waiter or waitress to add water, beverage, soup, or other substances for a consumer. Since the light emitting area and the container placing area are staggered with each other, the light, which is projected out of the light emitting area, will not be hidden by the container such that the waiter or waitress can see the light, which is projected through the light emitting area, clearly at any positions in a store. Furthermore, when the current weight of the container and the substance is smaller than the weight threshold, the weight sensing device of the invention may also drive the notification module to generate the notification message through the signal detecting module so as to notify the waiter or waitress to add water, beverage, soup, or other substances for the consumer, wherein the notification module may be installed on a counter of the store or may be carried with the waiter or waitress. Accordingly, the waiter or waitress can add water, beverage, soup, or other substances for the consumer in time according to the light or the notification message no matter where he or she is located in the store such that the store will make a good impression and service quality on the consumer.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a weight sensing device according to an embodiment of the invention.

FIG. 2 is a schematic diagram illustrating a container, which contains a substance, placed on a container placing area of the weight sensing device shown in FIG. 1.

FIG. 3 is a schematic diagram illustrating three types of notification messages formed by the light emitted by the light emitting module shown in FIG. 2.

FIG. 4 is a schematic diagram illustrating a weight sensing system according to another embodiment of the invention.

FIG. 5 is a schematic diagram illustrating a container, which contains a substance, placed on the weight sensing device shown in FIG. 4.

### DETAILED DESCRIPTION

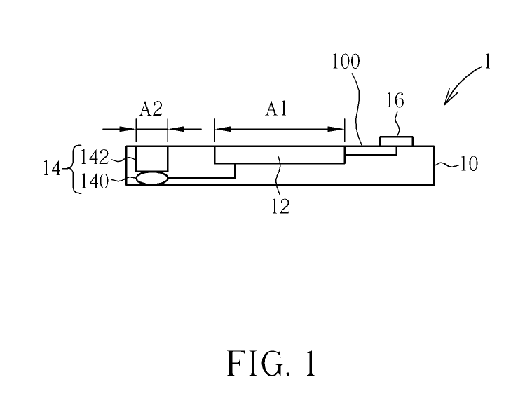

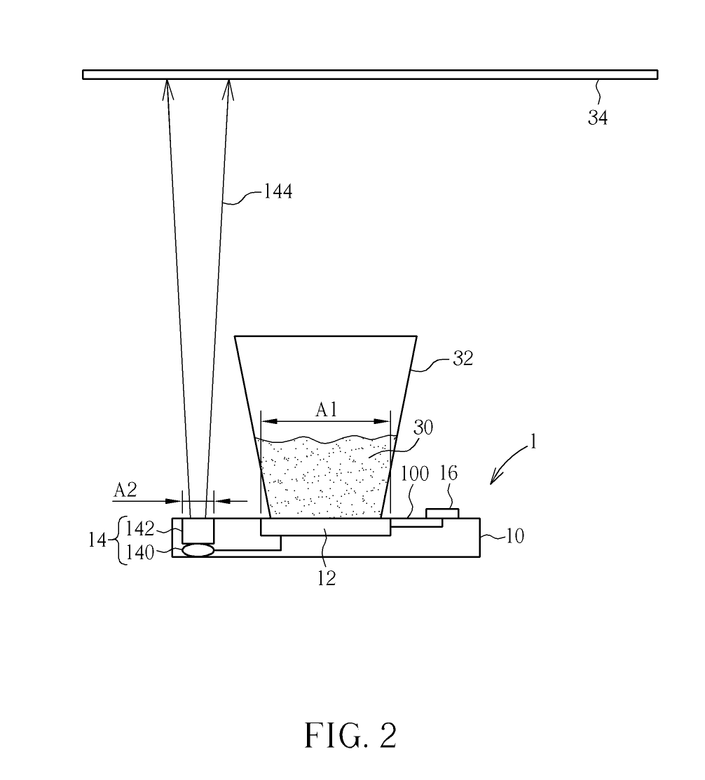

Referring to FIGS. 1 and 2, FIG. 1 is a schematic diagram illustrating a weight sensing device 1 according to an embodiment of the invention, and FIG. 2 is a schematic diagram illustrating a container 32, which contains a substance 30, placed on a container placing area A1 of the weight sensing device 1 shown in FIG. 1. As shown in FIG. 1, the weight sensing device 1 comprises a casing 10, a weight sensing module 12, a light emitting module 14 and an input module 16. A container placing area A1 and a light emitting area A2 are defined on a surface 100 of the casing 10 and staggered with each other. The light emitting area A2 is transparent. The weight sensing module 12 is disposed in the casing 10 and corresponding to the container placing area A1. The weight sensing module 12 records a weight threshold. The light emitting module 14 is disposed in the casing 10 and corresponding to the light emitting area A2. The light emitting module 14 is electrically connected to the weight sensing module 12. In this embodiment, the weight sensing module 12 is disposed below the container placing area A1 and the light emitting module 14 is disposed below the light emitting area A2 such that the weight sensing module 12 and the light emitting module 14 are staggered with each other. The input module 16 is disposed on the casing 10 and electrically connected to the weight sensing module 12. The input module 16 is used for setting the weight threshold.

In this embodiment, the light emitting module 14 comprises a light emitting unit 140 and a lens unit 142, wherein the light emitting unit 140 is electrically connected to the weight sensing module 12 and the lens unit 142 is arranged between the light emitting unit 140 and the light emitting area A2. In practical applications, the weight sensing module 12 may be a pressure sensor with data comparison/processing functions, the light emitting unit 140 may be a light emitting diode or other light sources, and the input module 16 may be a button, touch display panel or other operation interfaces.

As shown in FIG. 2, when a container 32, which contains a substance 30, is placed on the container placing area A1, the weight sensing module 12 senses a current weight of the container 32 and the substance 30 and compares the current weight with the weight threshold. The container 32 may be a cup, bowl, pot, etc. and the substance 30 may be water, beverage, soup or other substances capable of being contained in the container 32. When the current weight is smaller than the weight threshold, the weight sensing module 12 drives the light emitting unit 140 of the light emitting module 14 to emit light. Since the light emitting area A2 is transparent, the light 144 emitted by the light emitting module 14 will be projected through the light emitting area A2. In this embodiment, the lens unit 142 is used for condensing the light 144 emitted by the light emitting unit 140 such that the condensed light 144 is projected through the light emitting area A2, so as to strengthen the light 144 projected through the light emitting area A2. In general, the light 144 projected through the light emitting area A2 will be projected to, but not limited to, a ceiling 34 of a store. For example, the light 144 projected through the light emitting area A2 may be also projected to a wall or other visible positions. On the contrary, when the current weight is larger than the weight threshold, the light emitting unit 140 of the light emitting module 14 does not emit light.

In other words, when the current weight of the container 32 and the substance 30 is smaller than the weight threshold, it is necessary to add the substance 30 (e.g. water, beverage, soup, etc.) into the container 32. Since the light emitting area A2 and the container placing area A1 are staggered with each other, the light 144, which is projected through the light emitting area A2, will not be blocked by the container 32 such that the waiter or waitress can see the light 144, which is projected through the light emitting area A2, clearly at any positions in a store. At this time, the waiter or waitress can add the substance 30 for the consumer in time according to the light projected on the ceiling 34. In this embodiment, the user may reset the weight threshold using the input module 16 so as to determine when to add the substance 30 for the consumer actively according to how much substance 30 remained in the container 32.

Furthermore, the weight sensing module 12 may further record a net weight of the container 32. When the weight sensing module 12 senses a weight smaller than the net weight of the container 32 (e.g. the container 32 is temporarily removed from the container placing area A1 of the casing 10), the weight sensing module 12 does not drive the light emitting unit 140 of the light emitting module 14 to emit light so as to avoid misunderstanding and disturbance for the waiter or waitress. In this embodiment, the weight sensing module 12 may sense and record the net weight of the container 32 automatically when the empty container 32 is placed on the weight sensing module 12 or, alternatively, a user may operate the input module 16 to input the net weight of the container 32.

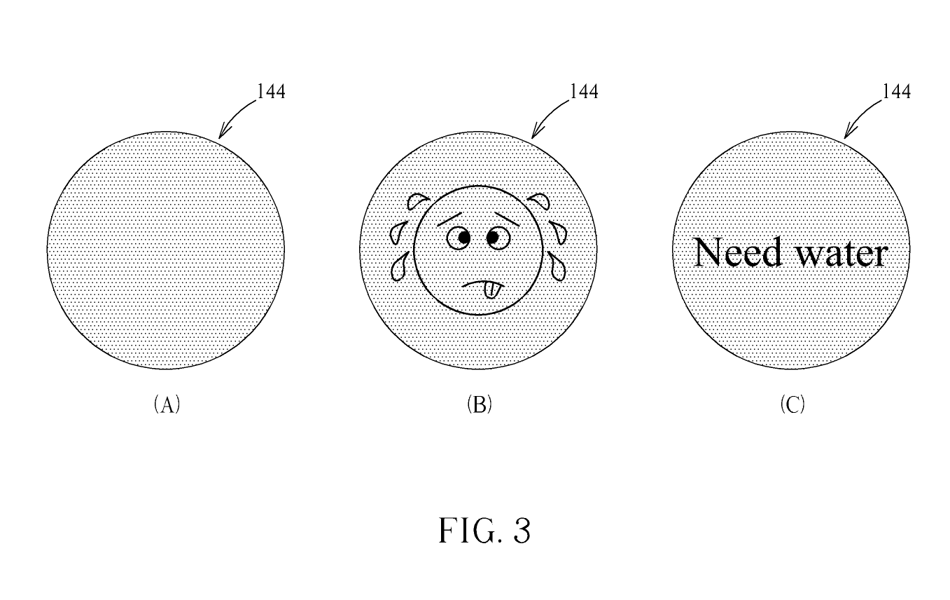

Referring to FIG. 3, FIG. 3 is a schematic diagram illustrating three types of notification messages formed by the light 144 emitted by the light emitting module 14 shown in FIG. 2. As shown in FIG. 3(A), the light 144 emitted by the light emitting module 14 may form a circular pattern with pure color (e.g. red circular pattern). As shown in FIG. 3(B), the light 144 emitted by the light emitting module 14 may form a specific pattern representing “need water”. As shown in FIG. 3(C), the light 144 emitted by the light emitting module 14 may form a text showing “need water”. In other words, the light 144 emitted by the light emitting module 14 may form a pure color, a pattern, a text or a combination thereof and it depends on practical applications.

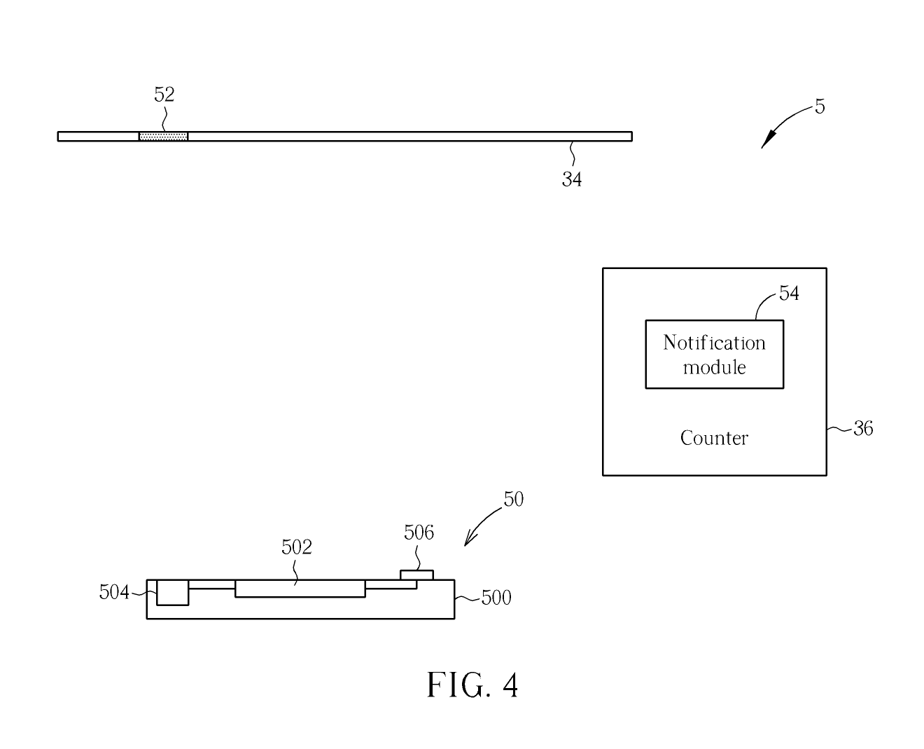

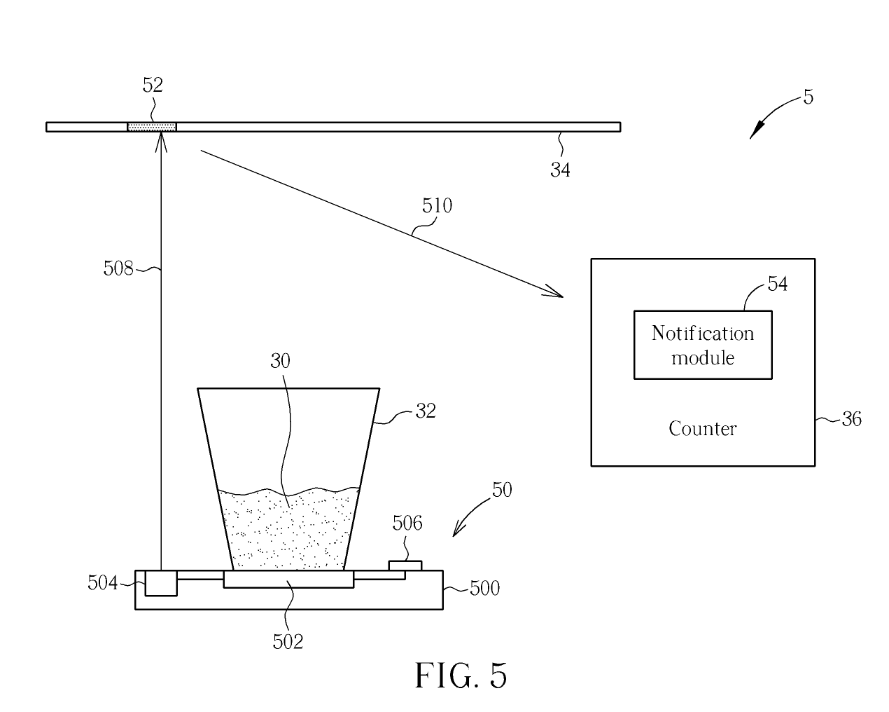

Referring to FIGS. 4 and 5, FIG. 4 is a schematic diagram illustrating a weight sensing system 5 according to another embodiment of the invention, and FIG. 5 is a schematic diagram illustrating a container 32, which contains a substance 30, placed on the weight sensing device 50 shown in FIG. 4. As shown in FIG. 4, the weight sensing system 5 comprises a weight sensing device 50, a signal detecting module 52 and a notification module 54, wherein the notification module 54 communicates with the signal detecting module 52. In practical applications, the notification module 54 and the signal detecting module 52 may communicate with each other through wired or wireless manner. It should be noted that the wired or wireless manner can be achieved by one skilled in the art and that will not be depicted herein.

The weight sensing device 50 comprises a casing 500, a weight sensing module 502, a signal generating module 504 and an input module 506. The weight sensing module 502 is disposed in the casing 500 and records a weight threshold. The signal generating module 504 is disposed in the casing 500 and electrically connected to the weight sensing module 502. The input module 506 is disposed on the casing 500 and electrically connected to the weight sensing module 502. The input module 506 is used for setting the weight threshold.

In this embodiment, the signal generating module 504 may be, but not limited to, an infrared transmitter and the signal detecting module 52 may be, but not limited to, an infrared receiver. In this embodiment, the signal detecting module 52 may be disposed on a ceiling 34 of a store and corresponding to the signal generating module 504. Furthermore, a lens unit (not shown) may be disposed in front of the infrared transmitter and used for condensing infrared light emitted by the infrared transmitter. In another embodiment, the signal generating module 504 and the signal detecting module 52 may be a couple of signal transmitter and receiver and those depend on practical applications.

As shown in FIG. 5, when a container 32, which contains a substance 30, is placed on the casing 500, the weight sensing module 502 senses a current weight of the container 32 and the substance 30 and compares the current weight with the weight threshold. When the current weight is smaller than the weight threshold, the weight sensing module 502 drives the signal generating module 504 to generate a first signal 508 (e.g. infrared signal). When the signal detecting module 52 detects the first signal 508, the signal detecting module 52 transmits a second signal 510 to the notification module 54. Afterward, the notification module 54 generates a notification message according to the second signal 510. On the contrary, when the current weight is larger than the weight threshold, the signal generating module 504 does not generate signal.

In this embodiment, the notification message may be a pattern, a text, a vibration, a sound, a visible light or a combination thereof. For example, the notification module 54 may be a display for displaying a pattern and/or a text so as to show which consumer needs some more substances 30; the notification module 54 may be a speaker for broadcasting sound so as to notify which consumer needs some more substances 30; the notification module 54 may be a device equipped with a plurality of vibration motors corresponding to different table numbers for generating vibration so as to point out which consumer needs some more substances 30; the notification module 54 may include a plurality of beacon lights corresponding to different table numbers for emitting visible light so as to point out which consumer needs some more substances 30; and the notification module 54 may be a combination composed of at least two of the aforesaid display, speaker, device equipped with a plurality of vibration motors and a plurality of beacon lights.

In this embodiment, the notification module 54 may be installed on a counter 36 of the store such that the waiter or waitress at the counter 36 can observe the notification message generated by the notification module 54 in time. In other embodiment, the notification module 54 may be carried with the waiter or waitress and it depends on practical applications.

Furthermore, the weight sensing module 502 may further record a net weight of the container 32. When the weight sensing module 502 senses a weight smaller than the net weight of the container 32 (e.g. the container 32 is temporarily removed from the casing 500), the weight sensing module 502 does not drive the signal generating module 504 to generate the first signal 508 such that the notification module 54 does not generate the notification message so as to avoid misunderstanding and disturbance for the waiter or waitress. In this embodiment, the weight sensing module 502 may sense and record the net weight of the container 32 automatically when the empty container 32 is placed on the weight sensing module 502 or, alternatively, a user may operate the input module 506 to input the net weight of the container 32.

It should be noted that the aforesaid weight sensing device 1 and the aforesaid weight sensing device 50 may be formed as a pad (e.g. cup pad) placed on a table or may be embedded in a table immediately according to practical applications.

Compared to the prior art, the weight sensing device of the invention can sense the current weight of the container (e.g. cup, bowl, pot, etc.) and the substance (e.g. water, beverage, soup, etc.) therein and emit light through the light emitting area when the current weight is smaller than the weight threshold, so as to notify a waiter or waitress to add water, beverage, soup, or other substances for a consumer. Since the light emitting area and the container placing area are staggered with each other, the light, which is projected through the light emitting area, will not be blocked by the container such that the waiter or waitress can see the light, which is projected through the light emitting area, clearly at any positions in a store. Furthermore, when the current weight of the container and the substance is smaller than the weight threshold, the weight sensing device of the invention may also drive the notification module to generate the notification message through the signal detecting module so as to notify the waiter or waitress to add water, beverage, soup, or other substances for the consumer, wherein the notification module may be installed on a counter of the store or may be carried with the waiter or waitress. Accordingly, the waiter or waitress can add water, beverage, soup, or other substances for the consumer in time according to the light or the notification message no matter where he or she is located in the store such that the store will make a good impression and service quality on the consumer.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A weight sensing device comprising:
a casing, a container placing area and a light emitting area being defined on a surface of the casing and staggered with each other;
a weight sensing module disposed in the casing and corresponding to the container placing area, the weight sensing module recording a weight threshold; and
a light emitting module disposed in the casing and corresponding to the light emitting area, the light emitting module being electrically connected to the weight sensing module;
wherein when a container, which contains a substance, is placed on the container placing area, the weight sensing module senses a current weight of the container and the substance and compares the current weight with the weight threshold; when the current weight is smaller than the weight threshold, the weight sensing module drives the light emitting module to emit light, which is projected through the light emitting area.

2. The weight sensing device of claim 1, wherein the light emitting module comprises a light emitting unit and a lens unit, the light emitting unit is electrically connected to the weight sensing module, the lens unit is arranged between the light emitting unit and the light emitting area and used for condensing the light emitted by the light emitting unit such that the condensed light is projected through the light emitting area.

3. The weight sensing device of claim 1, wherein the light emitted by the light emitting module forms a pure color, a pattern, a text or a combination thereof.

4. The weight sensing device of claim 1, further comprising an input module disposed on the casing and electrically connected to the weight sensing module, wherein the input module is used for setting the weight threshold.

5. The weight sensing device of claim 1, wherein the weight sensing module further records a net weight of the container, when the weight sensing module senses a weight smaller than the net weight of the container, the weight sensing module does not drive the light emitting module to emit light.

6. A weight sensing system comprising:
a weight sensing device comprising:
a casing;
a weight sensing module disposed in the casing, the weight sensing module recording a weight threshold; and
a signal generating module disposed in the casing and electrically connected to the weight sensing module;
a signal detecting module; and
a notification module communicating with the signal detecting module;
wherein when a container, which contains a substance, is placed on the casing, the weight sensing module senses a current weight of the container and the substance and compares the current weight with the weight threshold; when the current weight is smaller than the weight threshold, the weight sensing module drives the signal generating module to generate a first signal, the signal detecting module detects the first signal and then transmits a second signal to the notification module, and the notification module generates a notification message according to the second signal.

7. The weight sensing system of claim 6, wherein the signal generating module is an infrared transmitter and the signal detecting module is an infrared receiver.

8. The weight sensing system of claim 6, wherein the notification message is a pattern, a text, a vibration, a sound, a visible light or a combination thereof.

9. The weight sensing system of claim 6, wherein the weight sensing device further comprises an input module disposed on the casing and electrically connected to the weight sensing module, the input module is used for setting the weight threshold.

10. The weight sensing system of claim 6, wherein the weight sensing module further records a net weight of the container, when the weight sensing module senses a weight smaller than the net weight of the container, the weight sensing module does not drive the signal generating module to generate the first signal.
